(19) United States
(12) Patent Application Publication
(10) Pub. No.: US 2026/0343214 A1
(43) Pub. Date: Oct. 29, 2026

(54) TECHNIQUES FOR INTELLIGENT MANAGEMENT OF SECURE ELEMENT STORAGE

(71) Applicant: Apple Inc., Cupertino, CA (US)

(72) Inventors: Jean-Marc PADOVA, San Francisco, CA (US); Hyewon LEE, Cupertino, CA (US); Raj S. CHAUGULE, Santa Clara, CA (US); Vidur GUPTA, Atherton, CA (US)

(21) Appl. No.: 19/467,608

(22) Filed: Feb. 2, 2026

Related U.S. Application Data
(60) Provisional application No. 63/794,153, filed on Apr. 24, 2025.

(51) Int. Cl. H04W 8/24; H04L 9/40

(52) U.S. Cl. CPC H04W 8/245; H04L 63/0869

(57) ABSTRACT

The described embodiments relate to wireless communications, including techniques for intelligent management of storage of a secure element of a wireless device, such as controlling a size of an electronic subscriber identity module (eSIM) profile during download and installation to a memory of the secure element of the wireless device, adjusting an available memory for storage of eSIM profiles and/or applets, and/or characterizing usage and memory utilization of various eSIM profiles and/or applets to provide ordered rankings for management of the memory of the secure element. Exemplary secure elements include: i) an embedded universal integrated circuit card (eUICC) of an integrated UICC (iUICC) for storing eSIMs and associated applets, and ii) an embedded secure element (eSE) processor for storing secure transaction applets combined with an eUICC.

### CROSS-REFERENCE TO RELATED APPLICATIONS

The present application claims the benefit of U.S. Provisional Application No. 63/794,153, entitled “TECHNIQUES FOR INTELLIGENT MANAGEMENT OF SECURE ELEMENT STORAGE,” filed Apr. 24, 2025, the content of which is incorporated by reference herein in its entirety for all purposes.

### FIELD

The described embodiments relate to wireless communications, including techniques for intelligent management of storage of a secure element of a wireless device, such as controlling a size of an electronic subscriber identity module (eSIM) profile during download and installation to a memory of the secure element of the wireless device, adjusting an available memory for storage of eSIM profiles and/or applets, and/or characterizing usage and memory utilization of various eSIM profiles and/or applets to provide ordered rankings for management of the memory of the secure element.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. A wireless device can also include an embedded secure element (eSE) processor that can be used for secure transactions, such as for banking, credit cards, public transportation, etc. The eUICCs and/or iUICCs can include a non-volatile rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. . The use of multiple SIMs and/or eSIMs is expected to offer flexibility for access to multiple services of multiple wireless networks.

A wireless device can include a secure element (SE) such as an eUICC, an iUICC, and/or an eSE with associated limited memory, e.g., for storage of eSIMs and/or applets, each having variable storage requirements. Present implementations do not handle out-of-memory conditions gracefully. Techniques are needed to manage intelligently memory storage available in a memory of a SE of a wireless device.

### SUMMARY

The described embodiments relate to wireless communications, including techniques for intelligent management of memory storage of a secure element of a wireless device. The secure element can include an embedded universal integrated circuit (eUICC) or an eUICC combined with an embedded secure element (eSE) processor. The eUICC or the eUICC/eSE can include a limited size memory for storage of electronic subscriber identity module (eSIM) profiles, associated applets of the eSIM profiles, contactless applets associated with the eSE or the like. The memory is also used for storage of an operating system (OS) of the eUICC and free scratch space for OS functions.

Predictive storage management can track memory utilization for known eSIM profiles and applets to assist with determining memory requirements for an eSIM profiles prior to installation on a memory of a secure element. In some embodiments, an indication of a preference for a smaller and/or preferred size of an eSIM profile can be communicated to a mobile network operator (MNO) provisioning server during download and installation of the eSIM profile to the memory of the secure element of the wireless device. In some embodiments, an eSIM profile download and installation process can be paused and subsequently resumed to obtain a smaller size eSIM profile from the MNO provisioning server. In some embodiments, the eSIM profile download and installation process can be paused to allow for adjusting available memory for storage of eSIM profiles and/or applets on the memory of the secure element and subsequently resumed when additional memory is available for installation of the eSIM profile. In some embodiments, one or more modules of the wireless device can characterize usage and memory utilization of various eSIM profiles and/or applets to provide ordered rankings for management of the memory of the secure element. The ordered rankings of the eSIMs and/or applets can be displayed to allow for selection of one or more eSIM profiles and/or applets for deletion or offloading from the memory of the secure element. In some embodiments, one or more unused eSIM profiles are offloaded from the memory of the secure element to device storage. In some embodiments, one or more unused, older, and/or expired eSIM profiles are deleted from the memory of the secure element. In some embodiments, one or more applets of an eSE are offloaded and/or deleted from the memory of the secure element. In some embodiments, offloading and/or deletion of eSIM profiles and/or applets requires user input. In some embodiments, offloading and/or deletion of eSIM profiles and/or applets occurs automatically according to configuration of the wireless device and/or user configured preferences.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3 illustrates a block diagram of an exemplary system for remote profile management (RPM) of electronic subscriber identity module (eSIM) profiles of a wireless device, according to some embodiments.

FIGS. 4A, 4B, and 4C, illustrate flow diagrams of an example of interrupting an eSIM profile download procedure to obtain a smaller size eSIM profile to install on a secure element of a wireless device, according to some embodiments.

FIGS. 5A, 5B, and 5C, illustrate flow diagrams of an example of pausing and resuming an eSIM profile download procedure to clean up memory space to allow for installation of an eSIM profile to a secure element of a wireless device, according to some embodiments.

FIG. 6 illustrates a flow chart of an example of secure memory management to categorize eSIM profiles and/or embedded secure element (eSE) applets to free up memory space of a secure element of a wireless device, according to some embodiments.

FIG. 7 illustrates an exemplary presentation of sorted eSE applets and eSIM profiles for deletion from a memory of a secure element of a wireless device, according to some embodiments.

FIG. 8 illustrates a flow chart of an exemplary method to manage memory storage of a secure element of a wireless device by obtaining a smaller size eSIM profile during an eSIM profile installation procedure, according to some embodiments.

FIG. 9A illustrates a flow chart of another exemplary method to manage memory storage of a secure element of a wireless device by deleting one or more eSIM profiles and/or applets during an eSIM profile installation procedure, according to some embodiments.

FIG. 9B illustrates a flow chart of a further exemplary method to manage memory storage of a secure element of a wireless device by performing a memory management procedure during an eSIM profile installation procedure, according to some embodiments.

FIG. 10 illustrates a flow chart of an exemplary method to categorize eSIM profiles and/or applets for removal from a memory of a secure element of a wireless device, according to some embodiments.

FIG. 11 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

The described embodiments relate to wireless communications, including techniques for intelligent management of memory storage of a secure element of a wireless device. The secure element can include an embedded universal integrated circuit (eUICC), configured with a memory for storing an eUICC operating system (OS), maintaining free scratch space for the eUICC OS, and storing one or more electronic subscriber identity module (eSIM) profiles, with associated applets, for access to cellular wireless communication services. The secure element can also include an eUICC combined with an embedded secure element (eSE) processor, where the eUICC and the eSE share a memory, which can also be configured to store secure transaction applets, such as for banking, financial management, credit/debit card services, public transportation, and the like. The memory used by the eUICC (and by the eSE) is limited in size, and the growth of usable memory in successive generations of secure elements is outpaced by present and future storage requirements. The size of the baseline eUICC OS continues to increase with numerous features being added. The number and size of applets included with various eSIM profiles have increased, especially with contactless and other complex applets. The number of concurrent eSIM profiles used by a typical wireless device owner has grown, with some carriers, such as some mobile virtual network operators (MVNOs), favoring an eSIM profiles as a primary mechanism to offer cellular wireless services. Additionally, new eSIM-only wireless devices are entering the marketplace. Reaching the memory storage limit of secure elements is expected to be an ongoing issue, and present implementations for management of secure element memory do not handle out-of-space scenarios gracefully. Furthermore, predicting when a secure element memory’s limit will be reached is challenging. For example, a network provisioning server will indicate a size of an uninstalled bound profile package (BPP) that includes an eSIM profile for delivery to and installation on a memory of a secure element of a wireless device; however, the network provisioning server may only optionally provide an estimated size of the installed eSIM profile. The actual installed memory size of the installed eSIM profile and associated applets may differ from the estimated memory size, and the memory size required for future operation of the eSIM profile is not known. Presently, during installation of an eSIM profile on a memory of a secure element, there is no mitigation for recovering from a memory storage limit; the installation procedure fails, and the download session is lost.

Predictive storage management can track memory utilization for known eSIM profiles and applets to assist with determining memory requirements for an eSIM profile prior to installation on a memory of a secure element. Long term historical storage utilization of known eSIM profiles, observed by the wireless device and/or with anonymous crowd sourcing of observations from multiple wireless devices, can be provided to build a long term usage model for eSIM profiles. Dynamic management of memory storage of a secure element can also be used to obtain a more appropriately sized eSIM profile and/or to free up memory space for installation of a new eSIM profile. In some embodiments, an eSIM profile provisioning procedure can be interrupted to request, from a mobile network operator (MNO) network provisioning server, such as a subscription manager data preparation plus (SM-DP+) server, a smaller size BPP that includes a smaller size eSIM profile for installation on a secure element of the wireless device. In some embodiments, an indication of a preference for a smaller size eSIM profile (or BPP) and/or preferred size of an eSIM profile (or BPP) can be communicated to the MNO provisioning server during download and installation of the eSIM profile to the memory of the secure element of the wireless device. In some embodiments, an eSIM download and installation process can be paused and subsequently resumed to obtain a smaller size eSIM profile from the MNO provisioning server.

In some embodiments, the eSIM profile download and installation process can be paused to allow for adjusting available memory for storage of eSIM profiles and/or applets on the memory of the secure element and subsequently resumed when additional memory is available for installation of the eSIM profile. One or more eSIM profiles and/or applets can be deleted or offloaded to external storage to free up memory for installation of a new eSIM profile. In some embodiments, one or more unused eSIM profiles or applets are offloaded to on-device storage (external to the eUICC memory). In some embodiments, one or more unused, older, and/or expired eSIM profiles or applets can be deleted from the memory of the secure element. In some embodiments, management of eSIM profiles and/or applets can be performed manually or automatically. After memory cleanup, the eSIM profile download and installation process can be resumed to obtain and install the new eSIM profile on the memory of the secure element. Present wireless communication standards, such as messages communicated via an ES10b interface between a local profile assistant (LPA) of a wireless device and an eUICC can be expanded to include commands for pausing and resuming an eSIM profile download and installation session. In some embodiments, session keys for the download and installation session can be maintained and not required to be re-established when resuming a paused download and installation session.

In some embodiments, one or more modules of the wireless device can characterize usage and memory utilization of various eSIM profiles and/or applets to provide ordered rankings for management of the memory of the secure element. The ordered rankings of the eSIMs and/or applets can be displayed to allow for selection of one or more eSIMs and/or applets for deletion or offloading from the memory of the secure element. In some embodiments, one or more unused eSIM profiles are offloaded from the memory of the secure element to device storage. In some embodiments, one or more unused, older, and/or expired eSIMs are deleted from the memory of the secure element. In some embodiments, one or more applets of an eSE are offloaded and/or deleted from the memory of the secure element. In some embodiments, offloading and/or deletion of eSIM profiles and/or applets requires user input. In some embodiments, offloading and/or deletion of eSIM profiles and/or applets occurs automatically according to configuration of the wireless device and/or user configured preferences.

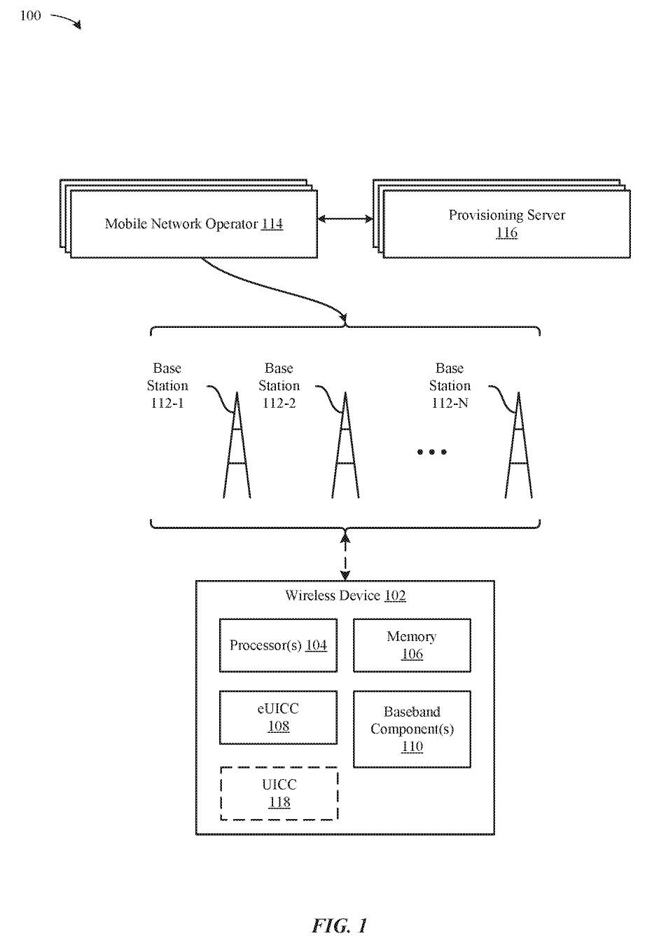

These and other embodiments are discussed below with reference to FIGS. 1 through 11; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIM (eSIM) profiles and/or an iUICC providing one or more eSIM profiles. A wireless device 102 that includes multiple active (enabled) SIMs and/or eSIM profiles can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIM profiles for accessing services offered by one or more different MNOs 114 via communication through base stations 112-1 to 112-N. To be able to access services provided by the MNOs, one or more eSIM profiles can be provisioned to the eUICC 108 of the wireless device 102. The wireless device 102 can include wireless circuitry, including the baseband component 110 and at least one transmitter/receiver, also referred to as a transceiver to transmit to and receive cellular wireless signals from network access network entities of a cellular wireless network. In some embodiments, the provisioning server 116 can provide an indication to the wireless device 102 via a discovery service server of availability of an eSIM profile to download to the wireless device 102 or of a remote profile management (RPM) update for an eSIM profile resident of the eUICC 108 of the wireless device 102. In some embodiments, the wireless device 102 can initiate a procedure to download an eSIM profile from a provisioning server 116, and one or more components (or modules) of the wireless device 102 can determine to request and obtain a smaller size equipment eSIM profile from the provisioning server 116 to accommodate an available memory limitation for a memory on which to store the eSIM profile. In some embodiments, the one or more components (or modules) of the wireless device 102 can implement a memory management procedure to free up memory storage for an eSIM profile from the provisioning server 116. In some embodiments, the one or more components (or modules) of the wireless device 102 can pause an ongoing eSIM profile provisioning (e.g., download and installation) procedure between a secure element, e.g., the eUICC 108, of the wireless device 102 and an MNO provisioning server 116 to obtain a smaller size eSIM profile or to perform a memory management procedure, e.g., delete and/or offload one or more eSIM profiles, associated eSIM profile applets, or other applets stored on a memory of the secure element, and subsequently resuming the ongoing eSIM profile provisioning procedure with the MNO provisioning server 116.

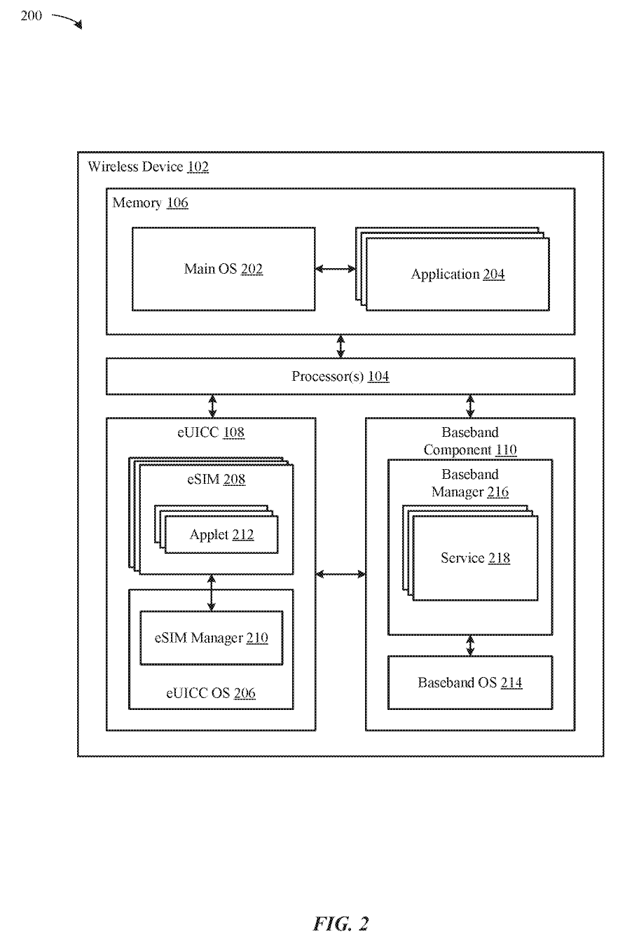

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIM 208 profiles within the eUICC 108 and providing the baseband component 110 with access to the eSIM 208 profiles to provide access to wireless services for the wireless device 102. The eUICC OS 206 can include an eSIM manager 210, which can perform management functions for various eSIM 208 profiles. Each eSIM 208 profile can include a number of applets 212 that define the manner in which the eSIM 208 profile operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM 208 profile data) from the provisioning server 116 for purposes of managing eSIM 208 profiles. The baseband manager 216 can be configured to implement services 218, which represent a collection of software modules that are instantiated by way of the various applets 212 of enabled eSIM 208 profiles that are included in the eUICC 108. For example, services 218 can be configured to manage different connections between the wireless device 102 and MNOs 114 according to the different eSIMs 208 that are enabled within the eUICC 108. In some embodiments, a processor 104 of the wireless device 102 and/or the eUICC 108 can include a local profile assistance (LPA) module to assist with management of eSIM 208 profiles on the eUICC 108 of the wireless device 102.

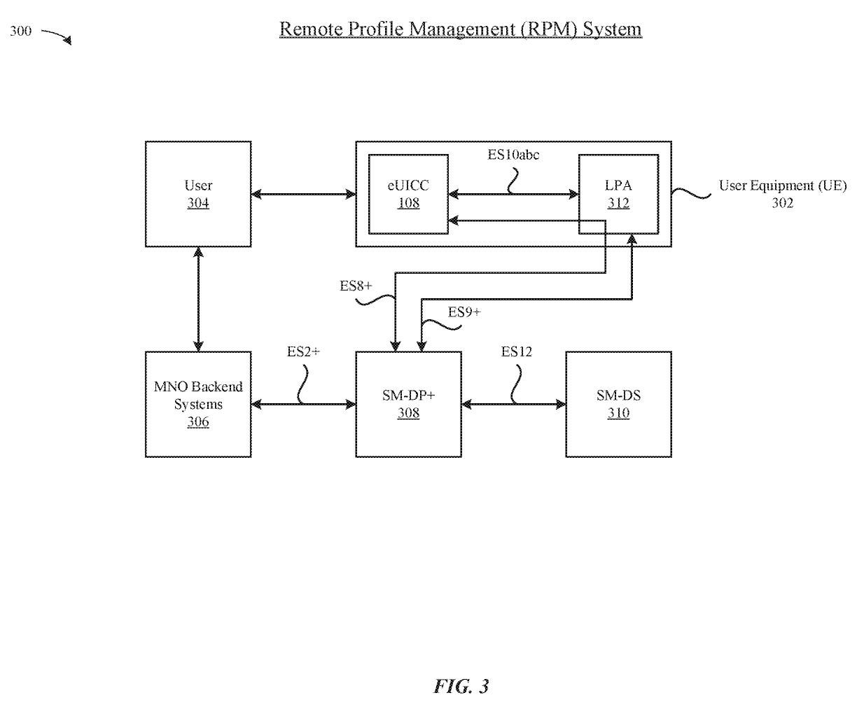

FIG. 3 illustrates a block diagram 300 of an exemplary system for providing remote profile management (RPM) of one or more eSIM 208 profiles stored on an eUICC 108 of a user equipment (UE) 302. A user 304 of the UE 302 can interact with MNO backend systems 306 associated with an MNO 114 to obtain and/or manage an eSIM 208 profile for the UE 302, e.g., to subscribe to and/or modify cellular wireless service provided by the MNO 114 via credentials of the eSIM 208 profile. The MNO backend systems 306 can communicate via an ES2+ interface with an MNO provisioning server 116, e.g., a subscription manager data preparation plus (SM-DP+) server 308, to order preparation of an eSIM 208 profile, provide an update to an eSIM 208 profile for the UE 302, and/or provide other eSIM 208 profile administrative functions. The SM-DP+ 308 can be connected via an ES12 interface to a subscription manager discovery server (SM-DS) 310 that can be accessed by the UE 302 via an ES11 interface. The SM-DP+ 308 can communicated via the ES12 interface to register event records for the UE 302 at the SM-DS 310. The SM-DP+ 308 can also delete event records for the UE 302 at the SM-DS 310 via messages over the ES12 interface. The SM-DS 310 can aggregate eSIM 208 profile events for the UE 302 for one or more MNOs 114 and provide notification to the UE 302, via the ES11 interface, of availability of one or more eSIM profile events for the eUICC 108 of the UE 302, e.g., via a push notification message to the UE 302, responsive to a pull notification message from the UE 302, where notification can occur periodically at regular intervals and/or manually on demand. The SM-DS 310 can provide information over the ES11 interface via notification messages to the UE 302 regarding an eSIM 208 profile available to download to the eUICC 108 of the UE 302 and/or an eSIM 208 profile RPM procedure to be executed for an eSIM 208 profile on the eUICC 108 of the UE 302. The eUICC 108 of the UE 302 can be connected via ES10a, ES10b, and ES10c interface to an LPA 312 of the UE 302. In particular, the ES10b interface provides a channel for transport of a bound profile package (BPP) between the LPA 312 and the eUICC 108. The eUICC 108 of the UE 302 can communicate with the SM-DP+ 308 via a ES8+ interface that provides a secure channel to manage download and installation of an eSIM 208 profile from the SM-DP+ 308 to the eUICC 108 of the UE 302. The LPA 312 of the UE 302 can also communicate with the SM-DP+ 308 via an ES9+ interface to provide secure transport and management of the BPP that securely contains an eSIM 208 profile and/or to provide for RPM procedures for one or more eSIM 208 profiles on the eUICC 108 of the UE 302.

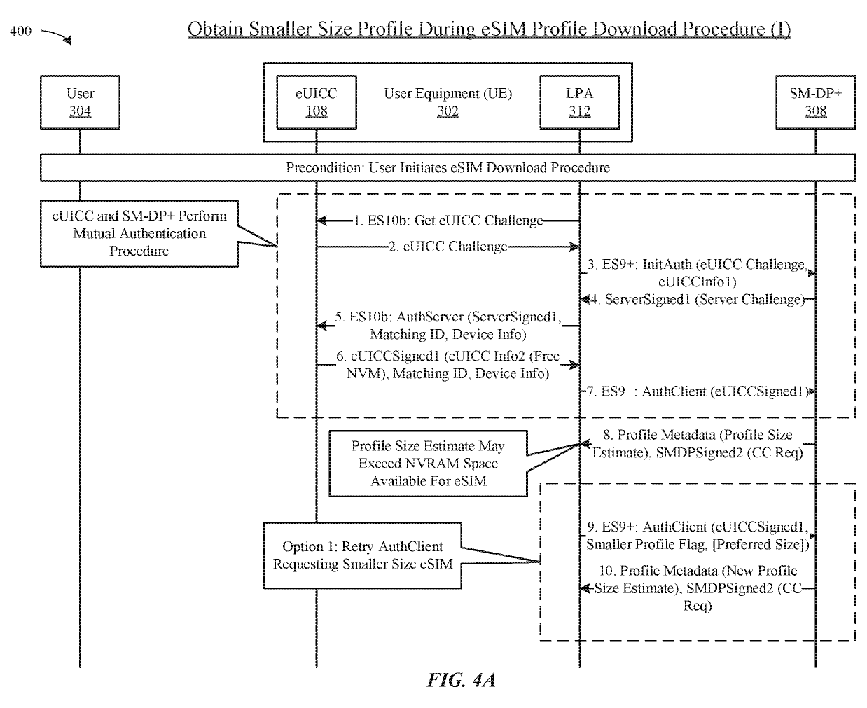

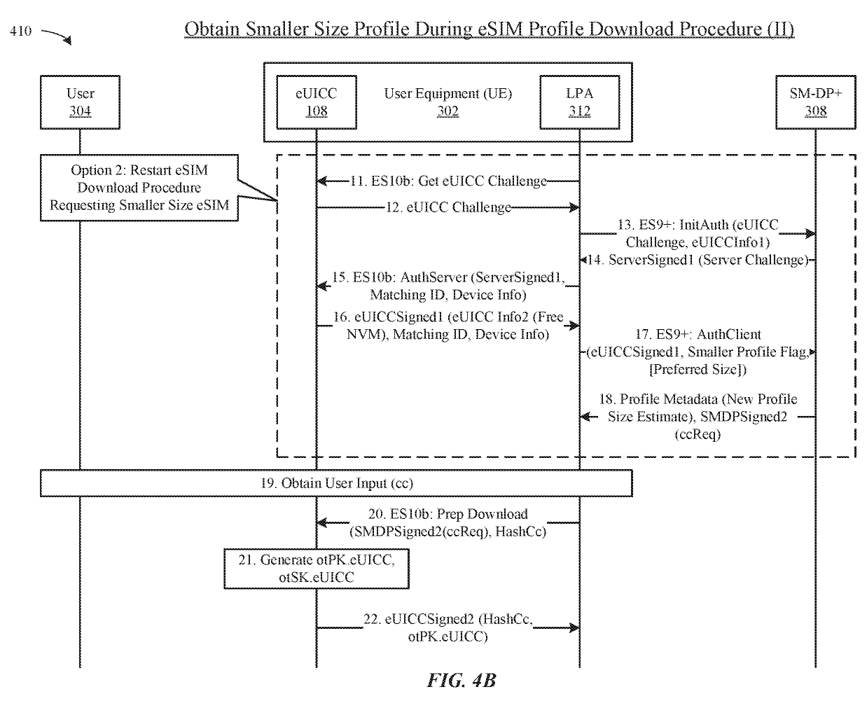

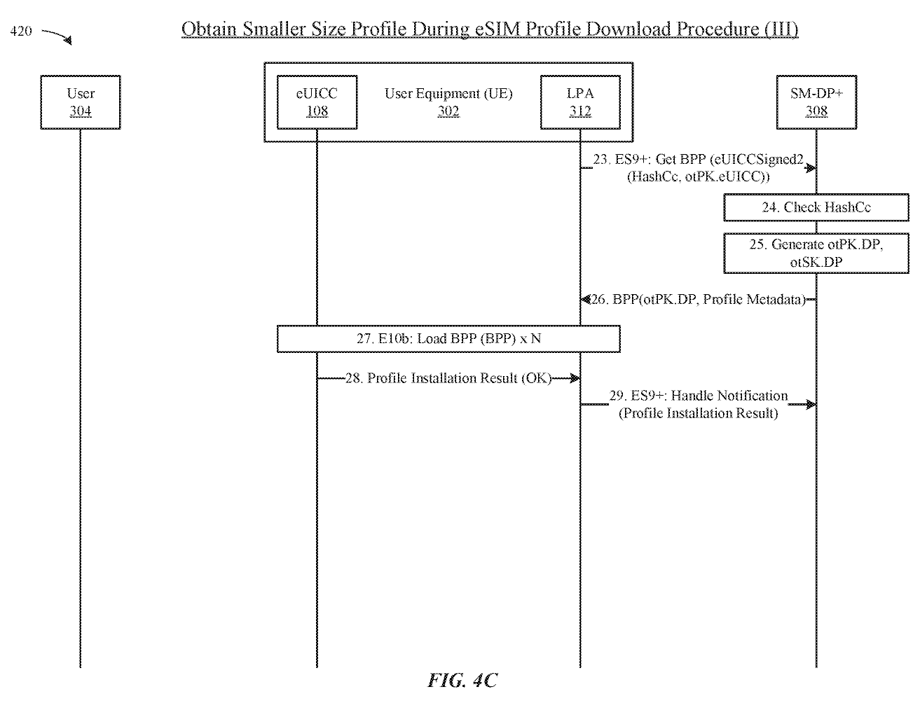

FIGS. 4A, 4B, and 4C, illustrate flow diagrams 400, 410, 420 of an exemplary scenario where a download procedure for an eSIM 208 profile, which is to be installed on an eUICC 108 of a wireless device, e.g., UE 302, from an MNO provisioning server 116, e.g., from SM-DP+ 308, is interrupted to obtain a smaller size eSIM 208 profile due to available memory limitations at the eUICC 108. The procedure illustrated in FIGS. 4A, 4B, and 4C, include two options, a first option where a portion of an authentication procedure is repeated to request a smaller size eSIM 208 profile, and a second option where the entire authentication procedure is restarted to request the smaller size eSIM 208 profile.

Beginning with flow diagram 400 of FIG. 4A, as a precondition, a user 304 can initiate an eSIM 208 profile download procedure for a UE 302, where the eSIM 208 profile can be associated with a cellular wireless service subscription and/or a specific cellular wireless plan of an MNO 114. Initially, the eUICC 108 of the UE 302 and the SM-DP+ 308 perform a mutual authentication procedure. At step 1, the LPA 312 of the UE 302 sends to the eUICC 108, via an ES10b interface, a message to obtain an eUICC challenge value. At step 2, the eUICC 108 responds to the LPA 312 with the requested eUICC challenge value. At step 3, the LPA 312 initiates mutual authentication with the SM-DP+ 308 by sending to the SM-DP+ 308, via an ES9+ interface, an authentication initialization message (e.g., an InitAuth message) that includes the eUICC challenge value and additional eUICC information. At step 4, the SM-DP+ responds to the LPA 312 with a server challenge value that is signed by the SM-DP+ for verification. At step 5, the LPA 312 provides to the eUICC 108, via the ES10b interface, a server authentication message (e.g., an AuthServer message) that includes the signed server challenge, a matching identifier (ID) value, and additional device information for the UE 302. At step 6, after successful verification of the server (SM-DP+ 308) signature and authentication of the SM-DP+ 308, the eUICC 108 provides to the LPA 312 a signed message (e.g., eUICCSigned1) that includes additional eUICC information, such as an amount of available memory space in a memory of the eUICC 108, the matching ID value, and the device information. At step 7, the LPA 312 sends to the SM-DP+ 308, via the ES9+ interface, a client authentication message (e.g., an AuthClient message) that includes the signed message obtained from the eUICC 108 at step 6. Upon successful verification of the client (eUICC 108) signature and authentication of the eUICC 108, the SM-DP+ continues with the eSIM download procedure. At step 8, the SM-DP+ 308 provides metadata for an eSIM 208 profile to be downloaded to the eUICC 108, where the metadata can include an estimate of an installed size of the eSIM 208 profile. In some circumstances, the estimated size of the installed eSIM 208 profile can exceed an available amount of free non-volatile random access memory (NVRAM) for storage of the eSIM 208 profile. At step 8, the SM-DP+ 308 can also provide with the eSIM 208 profile metadata to the LPA 312, an SM-DP+ signed control channel (CC) request.

When the LPA 312 determines that the available memory of the eUICC 108 for storage of the eSIM 208 profile to be installed is insufficient (or likely to be insufficient), the LPA 312 can attempt to obtain from the SM-DP+ 308 a smaller size eSIM 208 profile, which would provide access to the same cellular wireless services as the larger size eSIM 208 profile but occupy less space on the memory of the eUICC 108. As a first option, when the SM-DP+ 308 can accept a repeated client authentication message, at step 9, the LPA 312 can pause (implicitly) the eSIM 208 profile download procedure to send a second client authentication message that includes the signed eUICC message (as included at step 7) with a smaller profile flag value that indicates a request for a smaller size eSIM 208 profile for the eUICC 108 of the UE 302. In some embodiments, the second client authentication message can also include an indication of a preferred size for the smaller size eSIM 208 profile. When a smaller size eSIM 208 profile is available, the SM-DP+ 308 can respond to the LPA 312, at step 10, with profile metadata for a new eSIM 208 profile including a new (preferably smaller) eSIM 208 profile installed size estimate with the SM-DP+ signed CC request.

Continuing with the flow diagram 410 of FIG. 4B, as a second option, when the SM-DP+ 308 cannot accept a repeated client authentication message, the UE 302 can restart the eSIM download procedure and repeat the entire mutual authentication procedure with the SM-DP+ an additional time. At step 11, the LPA 312 of the UE 302 sends to the eUICC 108, via the ES10b interface, the message to obtain the eUICC challenge value. At step 12, the eUICC 108 responds to the LPA 312 with the requested eUICC challenge value. At step 13, the LPA 312 re-initiates mutual authentication with the SM-DP+ 308 by sending to the SM-DP+ 308, via the ES9+ interface, the authentication initialization message (e.g., the InitAuth message) that includes the eUICC challenge value and the additional eUICC information. At step 14, the SM-DP+ responds to the LPA 312 with the server challenge value that is signed by the SM-DP+ for verification. At step 15, the LPA 312 provides to the eUICC 108, via the ES10b interface, the server authentication message (e.g., the AuthServer message) that includes the signed server challenge, the matching identifier (ID) value, and the additional device information for the UE 302. At step 16, after successful verification of the server (SM-DP+ 308) signature and authentication of the SM-DP+ 308 (for a second time), the eUICC 108 provides to the LPA 312 the signed message (e.g., eUICCSigned1) that includes additional eUICC information, such as the amount of available memory space in a memory of the eUICC 108, the matching ID value, and the device information. At step 17, the LPA 312 sends to the SM-DP+ 308, via the ES9+ interface, the client authentication message (e.g., an AuthClient message) that includes the signed message obtained from the eUICC 108 at step 16, and also includes the smaller profile flag value that indicates a request for a smaller size eSIM 208 profile for the eUICC 108. In some embodiments, the second client authentication message also includes an indication of a preferred size for the smaller size eSIM 208 profile. When a smaller size eSIM 208 profile is available, the SM-DP+ 308 can respond to the LPA 312, at step 18, with profile metadata for a new eSIM 208 profile including a new (preferably smaller) eSIM 208 profile installed size estimate with the SM-DP+ signed CC request. At step 19, UE 302 obtains user input, such as a confirmation code (cc) to prove authorization to download the eSIM 208 profile to the eUICC 108. At step 20, the LPA 312 provides to the eUICC 108, via the ES10b interface, the SM-DP+ signed message received at step 18 and a hashed version of the cc obtained from the user 304 to cause preparation of the eUICC 108 for download of the eSIM 208 profile. At step 21, the eUICC 108 generates a one-time (ot) key pair, including a one-time eUICC public key (otPK.eUICC) and a one-time eUICC secret key (otSK.eUICC) to use for cryptographic protection of the download session for downloading the eSIM 208 profile to the eUICC 108. At step 22, the eUICC 108 provides to the LPA 312 a second eUICC signed message (e.g., an eUICCSigned2 message) that includes the hashed confirmation code (e.g., HashCc) and the one-time eUICC public key.

Continuing with the flow diagram 420 of FIG. 4C, at step 23, the LPA 312 sends to the SM-DP+ 308, via the ES9+ interface, a message to obtain the BPP of the eSIM 208 profile (e.g., a Get BPP message), where the message includes the second eUICC signed message received at step 22, that includes the hashed confirmation code and the one-time eUICC public key. At step 24, the SM-DP+ 308 checks the hashed confirmation code, e.g., to match a corresponding hashed version of the confirmation code available to the SM-DP+ 308. After successful matching, at step 25, the SM-DP+ 308 generates its own one-time (ot) key pair, including a one-time SM-DP+ public key (otPK.DP) and a one-time SM-DP+ secret key (otSK.DP). At step 26, the SM-DP+ 308 sends to the LPA 312 the BPP that includes metadata for the eSIM 208 profile and the one-time SM-DP+ public key. At step 27, the LPA 312 loads to the eUICC 108 via the ES10b interface, multiple (e.g., N) data blocks of the BPP that includes the eSIM 208 profile, where the eUICC 108 decrypts and assembles the data blocks to obtain and install the eSIM 208 profile on the memory of the eUICC 108. At step 28, the eUICC 108 provides to the LPA 312 a profile installation result indication (e.g., OK) for installation of the eSIM 208 profile on the memory of the eUICC 108. At step 29, the LPA 312 provides to the SM-DP+ 308 via the ES9+ interface, a message (e.g., a Handle Notification message) that includes the profile installation result indication. In some scenarios, the SM-DP+ may not have available a smaller size eSIM 208 profile to provide to the UE 302, and one or more components (and/or modules) of the UE 302 can pause an eSIM 208 profile download procedure to free up memory space on a memory of the eUICC 108 and subsequently resume the eSIM 208 profile download procedure to continue for installation of an eSIM 208 profile on the memory of the eUICC 108, as discussed further herein.

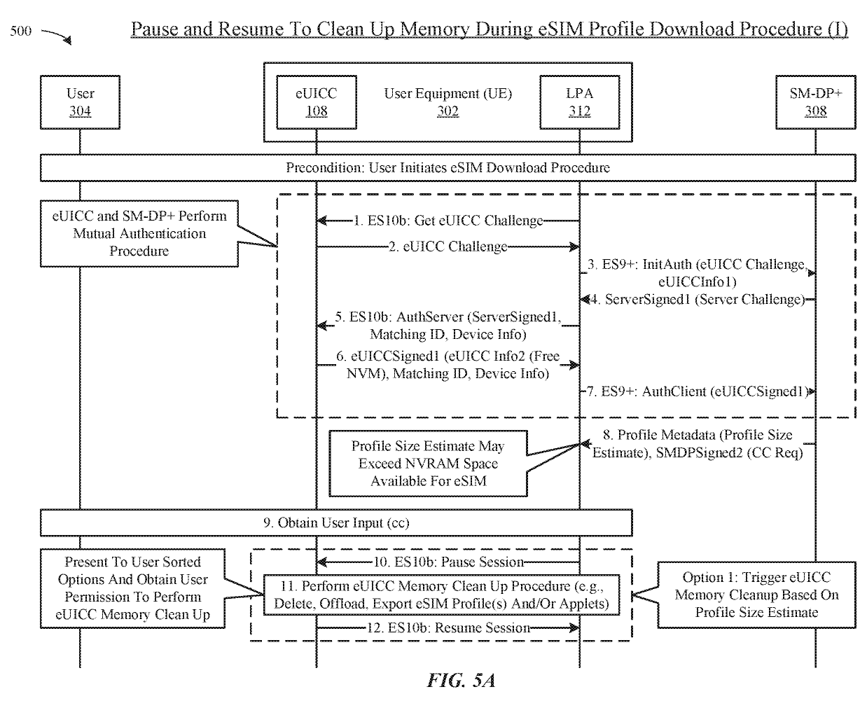

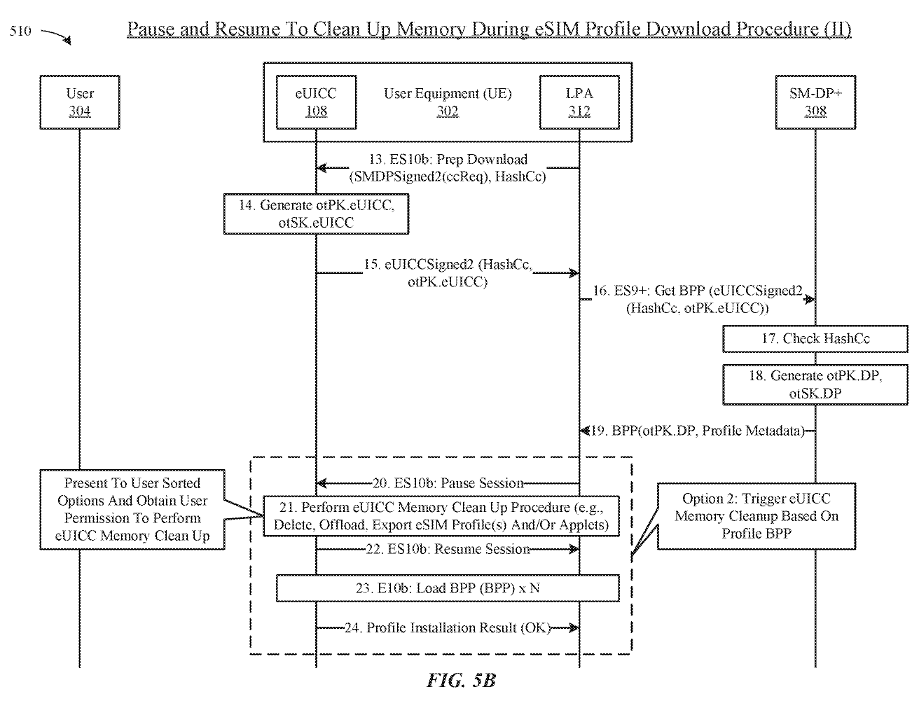

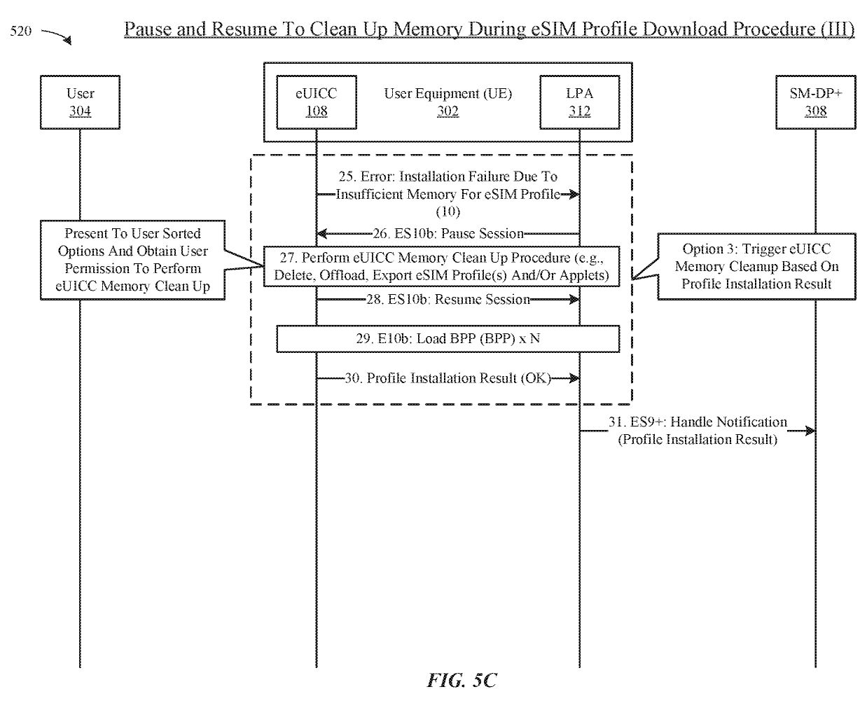

FIGS. 5A, 5B, and 5C, illustrate flow diagrams 500, 510, 520 of an exemplary scenario where a download procedure for an eSIM 208 profile, which is to be installed on an eUICC 108 of a wireless device, e.g., UE 302, from an MNO provisioning server 116, e.g., from SM-DP+ 308, is paused to obtain additional free memory space in a memory of the eUICC 108 to facilitate installation of the eSIM 208 profile. The procedure illustrated in FIGS. 5A, 5B, and 5C, includes three different options for triggering a memory management procedure to free up memory space of the eUICC 108. In a first option, the memory management procedure is triggered based on an estimated installed eSIM 208 profile size received from the SM-DP+ 308. In a second option, the memory management procedure is triggered based on eSIM 208 profile metadata information received from the SM-DP+ 308 in a BPP that includes the eSIM 208 profile to be installed. In a third option, the memory management procedure is triggered based on an error message received from the eUICC 108 indicating failure to install an eSIM 208 profile on the memory of the eUICC 108.

Beginning with flow diagram 500 of FIG. 5A, as a precondition, a user 304 can initiate an eSIM 208 profile download procedure for a UE 302, where the eSIM 208 profile can be associated with a cellular wireless service subscription and/or a specific cellular wireless plan of an MNO 114. Initially, the eUICC 108 of the UE 302 and the SM-DP+ 308 perform a mutual authentication procedure. At step 1, the LPA 312 of the UE 302 sends to the eUICC 108, via an ES10b interface, a message to obtain an eUICC challenge value. At step 2, the eUICC 108 responds to the LPA 312 with the requested eUICC challenge value. At step 3, the LPA 312 initiates mutual authentication with the SM-DP+ 308 by sending to the SM-DP+ 308, via an ES9+ interface, an authentication initialization message (e.g., an InitAuth message) that includes the eUICC challenge value and additional eUICC information. At step 4, the SM-DP+ responds to the LPA 312 with a server challenge value that is signed by the SM-DP+ for verification. At step 5, the LPA 312 provides to the eUICC 108, via the ES10b interface, a server authentication message (e.g., an AuthServer message) that includes the signed server challenge, a matching identifier (ID) value, and additional device information for the UE 302. At step 6, after successful verification of the server (SM-DP+ 308) signature and authentication of the SM-DP+ 308, the eUICC 108 provides to the LPA 312 a signed message (e.g., eUICCSigned1) that includes additional eUICC information, such as an amount of available memory space in a memory of the eUICC 108, the matching ID value, and the device information. At step 7, the LPA 312 sends to the SM-DP+ 308, via the ES9+ interface, a client authentication message (e.g., an AuthClient message) that includes the signed message obtained from the eUICC 108 at step 6. Upon successful verification of the client (eUICC 108) signature and authentication of the eUICC 108, the SM-DP+ continues with the eSIM download procedure. At step 8, the SM-DP+ 308 provides metadata for an eSIM 208 profile to be downloaded to the eUICC 108, where the metadata can include an estimate of an installed size of the eSIM 208 profile. In some circumstances, the estimated size of the installed eSIM 208 profile can exceed an available amount of free non-volatile random access memory (NVRAM) for storage of the eSIM 208 profile. At step 8, the SM-DP+ 308 can also provide with the eSIM 208 profile metadata to the LPA 312, an SM-DP+ signed control channel (CC) request.

When the LPA 312 determines that the available memory of the eUICC 108 for storage of the eSIM 208 profile to be installed is insufficient (or likely to be insufficient), the LPA 312 can interrupt the eSIM 208 profile download procedure to free up memory space for storing the eSIM 208 profile. In a first option, the LPA 312 triggers an eUICC 108 memory clean up procedure based on the estimated eSIM 208 profile size received from the SM-DP+ 308 at step 8. Initially at step 9, the UE 302 obtains user input, such as a confirmation code (cc) to prove authorization to download the eSIM 208 profile to the eUICC 108. (In some embodiments, the confirmation code can be obtained after performing a memory management procedure to free up memory space on the memory of the eUICC 108 to store the eSIM 208 profile.) At step 10, the LPA 312 sends to the eUICC 108, via the ES10b interface, a pause session message to halt temporarily the eSIM 208 profile download procedure. At step 11, the eUICC 108 and the LPA 312 (and/or additional components and/or modules of the UE 302) perform an eUICC 108 memory management procedure to obtain additional free memory space on a memory of the eUICC 108 to use for storage of the (yet to be installed) eSIM 208 profile. In some embodiments, the eUICC 108 memory management procedure includes deleting, offloading, and/or exporting one or more eSIM 208 profiles and/or one applets from the memory of the eUICC 108, e.g., transferred to device storage external to the eUICC 108 or deleted entirely. In some embodiments, one or more components and/or modules of the UE 302 determine a sorted ranking of eSIM 208 profiles and/or applets, e.g., based on one or more factors, such as installation date, activation status, expiration data, frequency of use, etc. The sorted ranking of eSIM 208 profiles and/or applets can be presented via an output interface to a user 304 of the UE 302 to obtain user permission and/or selection of one or more eSIM 208 profiles and/or applets to delete, offload, and/or export from the memory of the eUICC 108. After completion of the eUICC 108 memory management procedure (and in some embodiments dependent on sufficient free memory space being available), the eUICC 108 can continue the eSIM 208 profile download procedure by sending to the LPA 312, at step 12 via the ES10b interface, a resume session message.

Continuing with flow diagram 510 of FIG. 5B, at step 13, the LPA 312 provides to the eUICC 108, via the ES10b interface, the SM-DP+ signed message received at step 18 and a hashed version of the cc obtained from the user 304 to cause preparation of the eUICC 108 for download of the eSIM 208 profile. At step 14, the eUICC 108 generates a one-time (ot) key pair, including a one-time eUICC public key (otPK.eUICC) and a one-time eUICC secret key (otSK.eUICC) to use for cryptographic protection of the download session for downloading the eSIM 208 profile to the eUICC 108. At step 15, the eUICC 108 provides to the LPA 312 a second eUICC signed message (e.g., an eUICCSigned2 message) that includes the hashed confirmation code (e.g., HashCc) and the one-time eUICC public key. At step 16, the LPA 312 sends to the SM-DP+ 308, via the ES9+ interface, a message to obtain the BPP of the eSIM 208 profile (e.g., a Get BPP message), where the message includes the second eUICC signed message received at step 15, that includes the hashed confirmation code and the one-time eUICC public key. At step 17, the SM-DP+ 308 checks the hashed confirmation code, e.g., to match a corresponding hashed version of the confirmation code available to the SM-DP+ 308. After successful matching, at step 18, the SM-DP+ 308 generates its own one-time (ot) key pair, including a one-time SM-DP+ public key (otPK.DP) and a one-time SM-DP+ secret key (otSK.DP). At step 19, the SM-DP+ 308 sends to the LPA 312 the BPP that includes metadata for the eSIM 208 profile and the one-time SM-DP+ public key. In some embodiments, the metadata includes an estimated size for installation of the eSIM 208 profile included in the BPP.

Based on the eSIM 208 profile metadata included in the BPP, the LPA 312 can determine that the available memory of the eUICC 108 for storage of the eSIM 208 profile to be installed is insufficient (or likely to be insufficient), and the LPA 312 can interrupt the eSIM 208 profile download procedure to free up memory space for storing the eSIM 208 profile. In a second option, the LPA 312 triggers an eUICC 108 memory clean up procedure based on the metadata of the BPP. At step 20, the LPA 312 sends to the eUICC 108, via the ES10b interface, a pause session message to halt temporarily the eSIM 208 profile download procedure. At step 21, the eUICC 108 and the LPA 312 (and/or additional components and/or modules of the UE 302) perform an eUICC 108 memory management procedure to obtain additional free memory space on a memory of the eUICC 108 to use for storage of the (yet to be installed) eSIM 208 profile. In some embodiments, the eUICC 108 memory management procedure includes deleting, offloading, and/or exporting one or more eSIM 208 profiles and/or one applets from the memory of the eUICC 108, e.g., transferred to device storage external to the eUICC 108 or deleted entirely. In some embodiments, one or more components and/or modules of the UE 302 determine a sorted ranking of eSIM 208 profiles and/or applets, e.g., based on one or more factors, such as installation date, activation status, expiration data, frequency of use, etc. The sorted ranking of eSIM 208 profiles and/or applets can be presented via an output interface to a user 304 of the UE 302 to obtain user permission and/or selection of one or more eSIM 208 profiles and/or applets to delete, offload, and/or export from the memory of the eUICC 108. After completion of the eUICC 108 memory management procedure (and in some embodiments dependent on sufficient free memory space being available), the eUICC 108 can continue the eSIM 208 profile download procedure by sending to the LPA 312, at step 22 via the ES10b interface, a resume session message. At step 23, the LPA 312 loads to the eUICC 108 via the ES10b interface, multiple (e.g., N) data blocks of the BPP that includes the eSIM 208 profile, where the eUICC 108 decrypts and assembles the data blocks to obtain and install the eSIM 208 profile on the memory of the eUICC 108. At step 24, the eUICC 108 provides to the LPA 312 a profile installation result indication (e.g., OK) for installation of the eSIM 208 profile on the memory of the eUICC 108.

Continuing with flow diagram 520 of FIG. 5C, in a third option, an error message from the eUICC 108 indicating failure to install the eSIM 208 profile to the memory of the eUICC 108 can cause the LPA 312 to trigger an eUICC memory management procedure to free up memory to store the eSIM 208 profile. At step 25, the LPA 312 receives an error message that indicates installation of the eSIM 208 profile has failed due to insufficient memory for the eSIM 208 profile. At step 26, the LPA 312 sends to the eUICC 108, via the ES10b interface, a pause session message to halt temporarily the eSIM 208 profile download procedure. At step 27, the eUICC 108 and the LPA 312 (and/or additional components and/or modules of the UE 302) perform an eUICC 108 memory management procedure to obtain additional free memory space on a memory of the eUICC 108 to use for storage of the (yet to be installed) eSIM 208 profile. In some embodiments, the eUICC 108 memory management procedure includes deleting, offloading, and/or exporting one or more eSIM 208 profiles and/or one applets from the memory of the eUICC 108, e.g., transferred to device storage external to the eUICC 108 or deleted entirely. In some embodiments, one or more components and/or modules of the UE 302 determine a sorted ranking of eSIM 208 profiles and/or applets, e.g., based on one or more factors, such as installation date, activation status, expiration data, frequency of use, etc. The sorted ranking of eSIM 208 profiles and/or applets can be presented via an output interface to a user 304 of the UE 302 to obtain user permission and/or selection of one or more eSIM 208 profiles and/or applets to delete, offload, and/or export from the memory of the eUICC 108. After completion of the eUICC 108 memory management procedure (and in some embodiments dependent on sufficient free memory space being available), the eUICC 108 can continue the eSIM 208 profile download procedure by sending to the LPA 312, at step 28 via the ES10b interface, a resume session message. At step 29, the LPA 312 loads to the eUICC 108 via the ES10b interface, multiple (e.g., N) data blocks of the BPP that includes the eSIM 208 profile, where the eUICC 108 decrypts and assembles the data blocks to obtain and install the eSIM 208 profile on the memory of the eUICC 108. At step 30, the eUICC 108 provides to the LPA 312 a profile installation result indication (e.g., OK) for installation of the eSIM 208 profile on the memory of the eUICC 108. At step 31, the LPA 312 provides to the SM-DP+ 308 via the ES9+ interface, a message (e.g., a Handle Notification message) that includes the profile installation result indication.

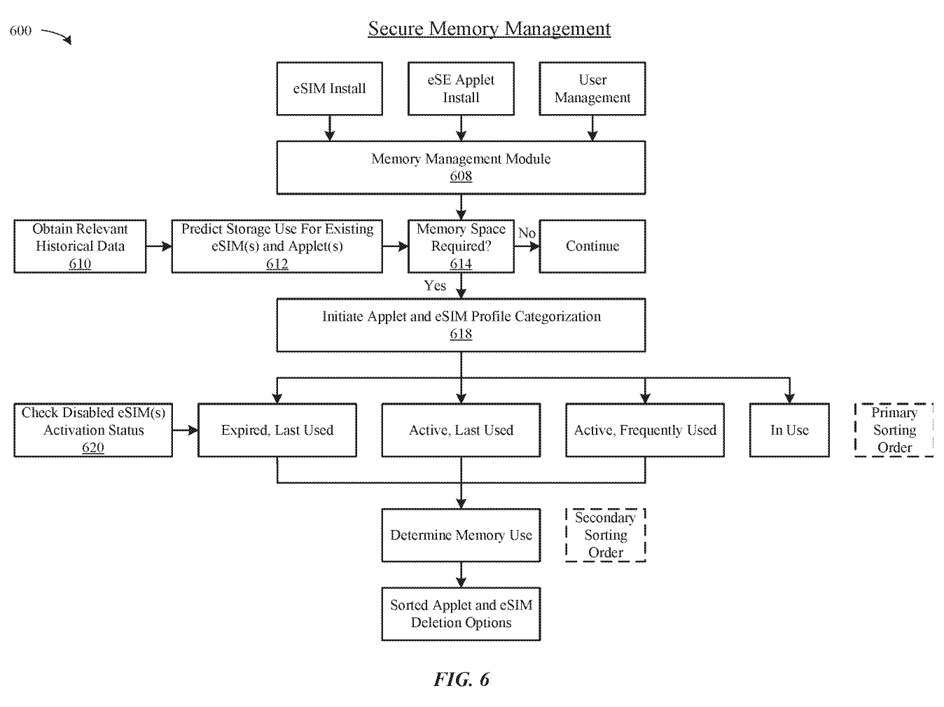

FIG. 6 illustrates a flow chart 600 of an example of secure memory management to categorize one or more eSIM 208 profiles and/or one or more embedded secure element (eSE) applets to provide a sorted ranking of the eSIM 208 profiles and/or eSE applets to be deleted, offloaded, and/or exported from a memory the eUICC 108. A memory management module 608, which can be resident on a processor of UE 302, e.g., a baseband component 110 or processor 104, can obtain information regarding installed eSIM 208 profiles, installed eSE applets, and device configuration and/or user preferences regarding secure memory management. The memory management module 608 can determine, at 614, based on relevant historical data 610 for eSIM 208 profiles and/or eSE applets known to the UE 302, as well as based on a predictive storage model 612 regarding memory use for existing eSIM 208 profiles and/or eSE applets, whether additional free memory space on a memory of the eUICC 108 is required, e.g., for installation of a new eSIM 208 profile and/or a new eSE applet. The predictive storage model can obtain information regarding historical memory requirements for eSIM 208 profiles including based on relevant hardware information that can assist with determination of memory size required, e.g., an eUICC hardware identifier (ID), a firmware vendor ID value, an eUICC ID (EID) value (or portion thereof). The hardware information and historical data can be used to predict an installed eSIM 208 profile size and requirements for future additional memory usage by the eSIM 208 profile. When additional memory space is determined to be required, at 618, a categorization of one or more eSIM 208 profiles and/or one or more eSE applets (e.g., unused) can be initiated. At 620, an activation status of one or more disabled eSIM 208 profiles can be checked with applicable MNO network servers. For example a disabled eSIM 208 profile can be temporarily enabled to access credentials to check with an associated network server of an MNO that provided cellular wireless services via the disabled eSIM 208 profile to determine whether the disabled eSIM 208 profile is still available for active use by the eUICC 108 of the UE 302. One or more eSIM 208 profiles can be categorized based on availability for and/or frequency of use, e.g., as “in use”, “active and frequently used”, “active and last used”, “expired and last used”. In some embodiments, expired and/or infrequently/least used eSIM 208 profiles can be preferred for deletion from the memory of the eUICC 108. In some embodiments, a sorted ranking of eSIM 208 profiles and a sorted ranking of eSE applets can be presented to a user 304 to obtain input for managing the memory of the eUICC 108, e.g., to select and/or approve deletion, offloading, and/or exporting of one or more eSIM 208 profiles and/or one or more eSE applets from the memory of the eUICC 108. In some embodiments, a primary sorting can be based on an activation status, an expiration status, a frequency of use status or the like. In some embodiments, a secondary sorting can be based on an amount of memory used by the respective eSIM 208 profile or eSE applet.

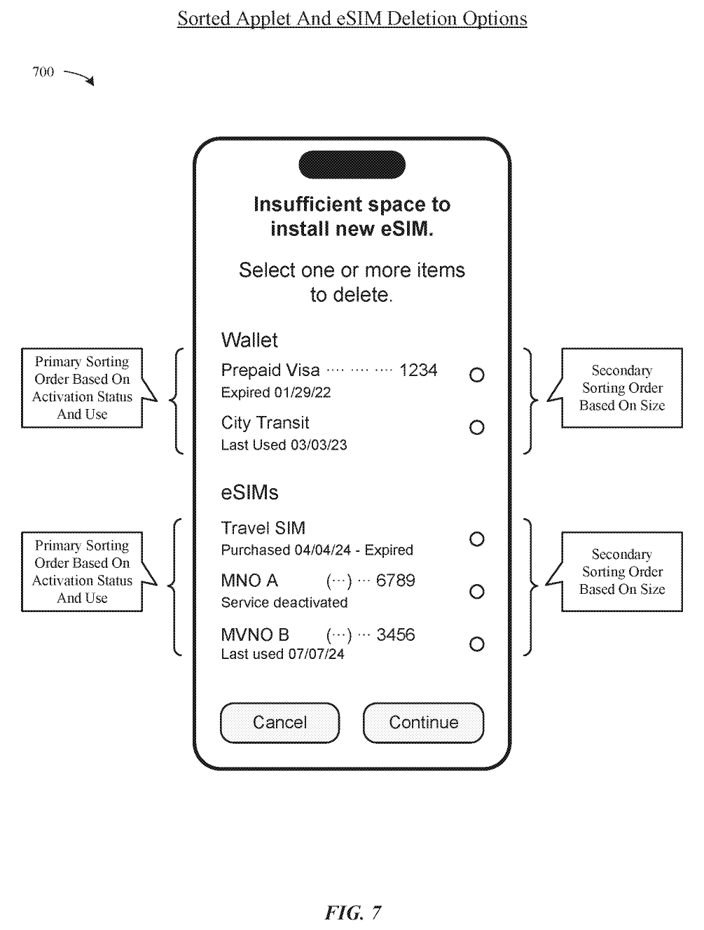

FIG. 7 illustrates a diagram 700 an exemplary presentation of sorted eSE applets and eSIM 208 profiles for deletion (or offloading or exporting) from a memory of a secure element, e.g., an eUICC 108 and/or a combined eUICC 108/eSE component of a UE 302. As illustrated in diagram 700, a notification can be presented via an output (e.g., a display) of the UE 302 indicated that there is insufficient memory space available to install a new eSIM 208 (or new applet). A user 304 of the UE 302 can be prompted to select one or more items to delete in order to free up space on a memory of the eUICC 108 (or of a combined eUICC 108/eSE component). In some embodiments, a memory of a combined eUICC 108/eSE can be divided into a portion of memory reserved for use by the eUICC 108, e.g., by an eUICC OS, a portion of memory reserved for use by the eSE, e.g., by an eSE firmware, and a portion of memory shared by both the eUICC 108 and the eSE. The notification regarding insufficient memory space can include a first section of select applets that may be deleted, offloaded, or exported from the memory. The notification regarding insufficient memory space can also include a second section of select eSIMs 208 that may be deleted, offloaded, or exported from the memory. The applets and eSIMs 208 can each be presented in a primary sorting order based on their activation status (e.g., expired, deactivated, or active) and on their frequency of use (e.g., by oldest most recent use date). The applets and eSIMs 208 can also be presented in a secondary sorting order based on an amount of memory that the applets occupy (or require for use) in the memory. Applets and/or eSIMs 208 that have expired, are deactivated, are infrequently used, or have not been used for an extended period of time can be prime candidates for presentation for the option to remove from the memory to free up space for installation of a new eSIM 208 or applet. In some embodiments, eSIMs 208 can only be deleted. In some embodiments, applets can be deleted, offloaded, or exported.

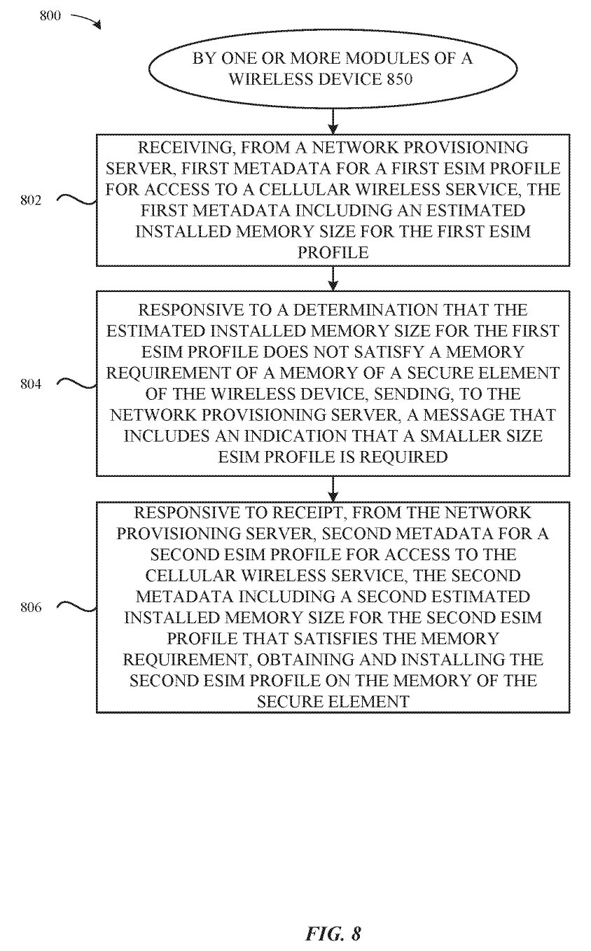

FIG. 8 illustrates a flow chart 800 of an exemplary method to manage memory storage of a secure element, e.g., an eUICC 108 or a combination eUICC 108/eSE, of a wireless device 850, e.g., a wireless device 102 or a UE 302, by obtaining a smaller size eSIM 208 profile during an eSIM 208 profile installation procedure. At 802, the method includes one or more modules of the wireless device 850 receiving, from a network provisioning server 116, e.g., an SM-DP+ 308, first metadata for a first eSIM 208 profile for access to a cellular wireless service, the first metadata including an estimated installed memory size for the first eSIM 208 profile. At 804, the method includes the one or more modules of the wireless device 850 responsive to a determination that the estimated installed memory size for the first eSIM 208 profile does not satisfy a memory requirement of a memory of the secure element, sending to the network provisioning server 116, a message that includes an indication that a smaller size eSIM 208 profile is required. At 806, the method includes the one or more modules of the wireless device 850 responsive to receipt, from the network provisioning server 116, second metadata for a second eSIM 208 profile for access to the cellular wireless service, the second metadata including a second estimated installed memory size for the second eSIM 208 profile that satisfies the memory requirement, obtaining and installing the second eSIM 208 profile on the memory of the secure element.

In some embodiments, the message includes a second client authentication message sent after completion of a mutual authentication procedure between the network provisioning server 116 and the secure element of the wireless device 850, where the mutual authentication procedure includes a first client authentication message sent to the network provisioning server 116. In some embodiments, the second client authentication message is sent to the network provisioning server 116 without restarting a second mutual authentication procedure between the network provisioning server 116 and the secure element of the wireless device 850. In some embodiments, the second client authentication message is sent to the network provisioning server 116 during a second mutual authentication procedure between the network provisioning server116 and the secure element of the wireless device 850. In some embodiments, the message includes a smaller profile flag to indicate a request for a smaller size eSIM 208 profile. In some embodiments, the message includes an indication of a preferred memory size for a smaller size eSIM 208 profile. In some embodiments, the message is communicated via an ES9+ standardized interface during a mutual authentication procedure between a local profile assistant (LPA) of the wireless device 850 and the network provisioning server 116. In some embodiments, the secure element includes an eUICC 108. In some embodiments, the memory is shared by an eUICC 108 and an embedded secure element (eSE) processor of the wireless device 850.

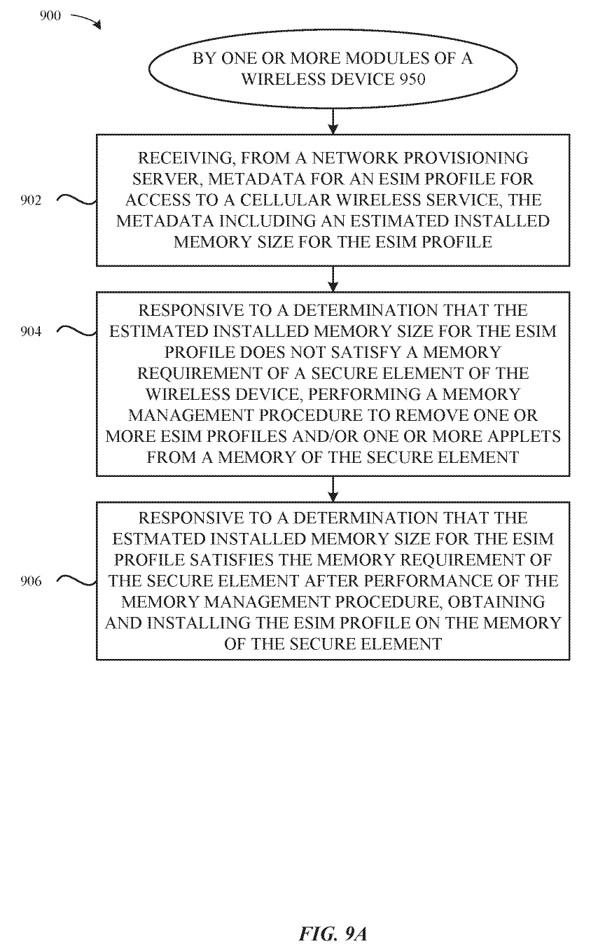

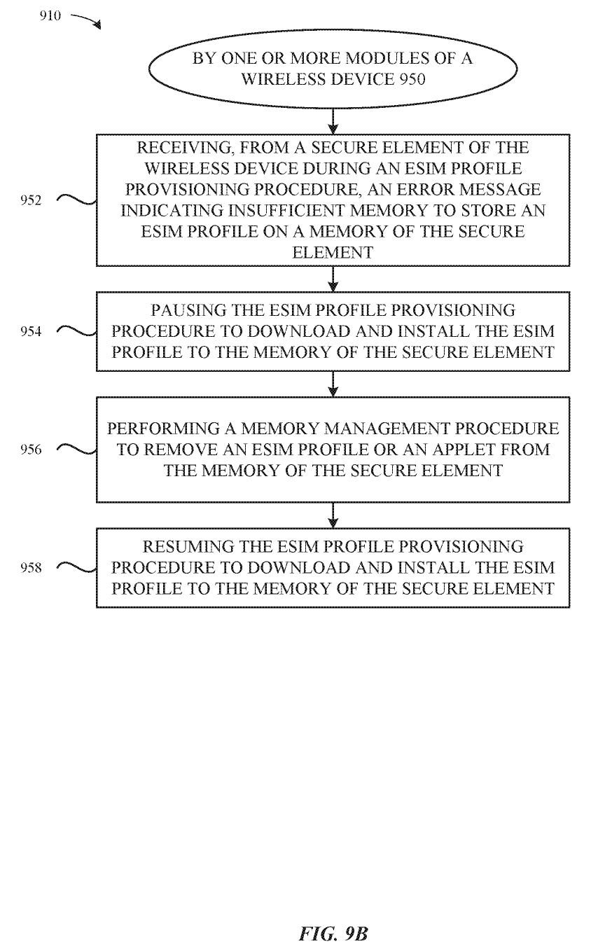

FIG. 9A illustrates a flow chart 900 of another exemplary method to manage memory storage of a secure element, e.g., an eUICC 108 or a combination eUICC 108/eSE, of a wireless device 950, e.g., a wireless device 102 or a UE 302, by performing a memory management procedure to free up memory space during an eSIM 208 profile provisioning procedure. At 902, the method includes one or more modules of a wireless device 950 receiving, from a network provisioning server 116, e.g., SM-DP+ 308, metadata for an eSIM 208 profile for access to a cellular wireless service, the metadata including an estimated memory size for the eSIM 208 profile. At 904, the method includes the one or more modules of the wireless device 950 responsive to a determination that the estimated installed memory size for the eSIM 208 profile does not satisfy a memory requirement of the secure element of the wireless device 950, performing a memory management procedure to remove one or more eSIM 208 profiles and/or one or more applets from a memory of the secure element. At 906, the method includes the one or more modules of the wireless device 950 responsive to a determination that the estimated installed memory size for the eSIM 208 profile satisfies the memory requirement of the secure element after performance of the memory management procedure, obtaining and installing the eSIM 208 profile on the memory of the secure element.

In some embodiments, performing the memory management procedure includes deleting an eSIM 208 profile or an applet from the memory of the secure element. In some embodiments, performing the memory management procedure further includes: i) presenting, via an output interface of the wireless device 950, an ordered ranking of one or more eSIM 208 profiles and/or one or more applets installed on the memory of the secure element, and ii) obtaining, via an input interface of the wireless device 950, a selection of the eSIM 208 profile or the applet to delete from the memory of the secure element. In some embodiments, performing the memory management procedure further includes: i) sending, to the secure element, a pause session message to suspend a provisioning session for the eSIM 208 profile between the secure element and the network provisioning server 116 prior to deletion of the eSIM 208 profile or the applet from the memory of the secure element, and ii) sending, to the secure element, a resume session message to resume the provisioning session for the eSIM 208 profile after deletion of the eSIM 208 profile or the applet from the memory of the secure element. In some embodiments, the pause session message and the resume session message are communicated via an ES10b standardized interface between an LPA of the wireless device and the secure element. In some embodiments, performing the memory management procedure further includes offloading the eSIM 208 profile or applet from the memory of the secure element to local storage of the wireless device 950 or to remote storage external to the wireless device 950 prior to deletion of the eSIM 208 profile or applet. In some embodiments, the metadata for the eSIM 208 profile is included in a message received from the network provisioning server 116 prior to receipt of a BPP that includes the eSIM 208 profile. In some embodiments, the metadata for the eSIM 208 profile is included in a BPP that includes the eSIM 208 profile received from the network provisioning server 116. In some embodiments, the secure element includes an eUICC 108. In some embodiments, the memory is shared by an eUICC 108 and an eSE processor of the wireless device 950.

FIG. 9B illustrates a flow chart 910 of a further method to manage memory storage of a secure element, e.g., an eUICC 108 or a combination eUICC 108/eSE of a wireless device 950, e.g., wireless device 102 or UE 302, by performing a memory management procedure during an eSIM 208 profile installation procedure. At 952, the method includes one or more modules of the wireless device 950 receiving, from the secure element of the wireless device 950 during an eSIM 208 profile provisioning procedure, an error message indicating insufficient memory to store an eSIM 208 profile on a memory of the secure element. At 954, the method includes the one or more modules of the wireless device 950 pausing the eSIM profile provisioning procedure to download and install the eSIM 208 profile to the memory of the secure element. At 956, the method includes the one or more modules of the wireless device 950 performing a memory management procedure to remove an eSIM 208 profile or an applet from the memory of the secure element. At 958, the method includes the one or more modules of the wireless device 950 resuming the eSIM 208 profile provisioning procedure to download and install the eSIM 208 profile to the memory of the secure element.

In some embodiments, performing the memory management procedure includes: i) presenting, via an output interface of the wireless device 950, an ordered ranking of one or more eSIM 208 profiles and/or one or more applets installed on the memory of the secure element, and ii) obtaining, via an input interface of the wireless device 950, a selection of the eSIM 208 profile or the applet to delete from the memory of the secure element. In some embodiments, pausing the eSIM 208 profile provisioning procedure includes sending a pause session message to the secure element via an ES10b standardized interface between an LPA 312 of the wireless device 950 and the secure element, and resuming the eSIM 208 profile provisioning procedure includes sending a resume session message to the secure element via the ES10b standardized interface between the LPA 312 and the secure element. In some embodiments, the secure element includes an eUICC 108. In some embodiments, the memory is shared by an eUICC 108 and an eSE processor of the wireless device 950.

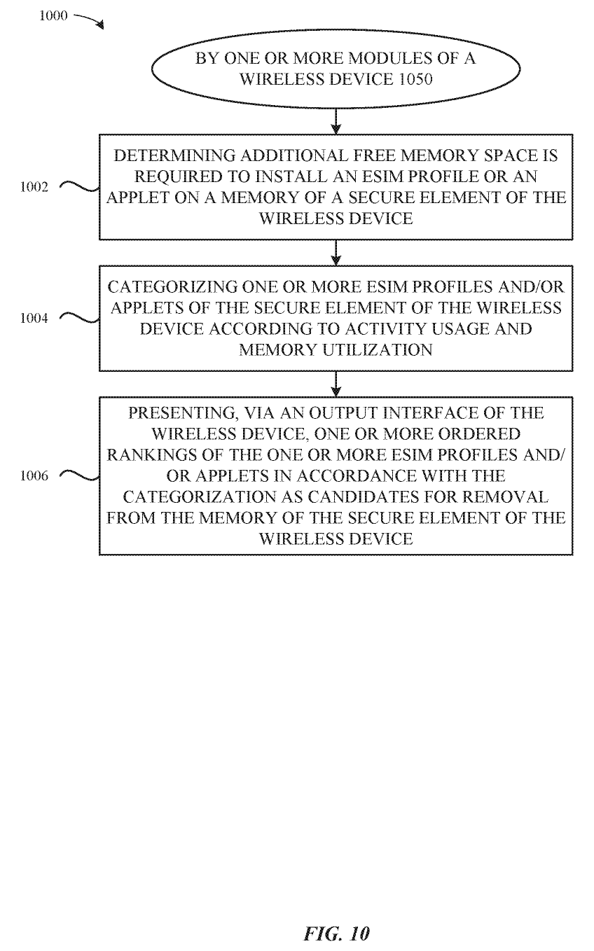

FIG. 10 illustrates an exemplary method to categorize eSIM 208 profiles and/or applets for removal from a memory of a secure element, e.g., an eUICC 108 or a combination eUICC 108/eSE, of a wireless device 1050, e.g., wireless device 102 or UE 302. At 1002, the method includes one or more modules of the wireless device 1050 determining additional free memory space is required to install an eSIM 208 profile or an applet on a memory of the secure element of the wireless device 1050. At 1004, the method includes the one or more modules of the wireless device 1050 categorizing one or more eSIM 208 profiles and/or applets of the secure element of the wireless device 1050 according to activity usage and memory utilization. At 1006, the method incudes the one or more modules of the wireless device 1050 presenting, via an output interface of the wireless device 1050, one or more ordered rankings of the one or more eSIM 208 profiles and/or applets in accordance with the categorization as candidates for removal from the memory of the secure element of the wireless device 1050. In some embodiments, removal can include deletion, offloading, and/or exporting.

In some embodiments, the method further includes receiving, via an input interface of the wireless device 1050, a selection of at least one eSIM 208 profile or at least one applet to remove from the memory of the secure element of the wireless device 1050. In some embodiments, categorizing the one or more eSIM 208 profiles includes determining an activation status of at least one disabled eSIM 208 profile of the one or more eSIM 208 profiles. In some embodiments, categorizing the one or more eSIM 208 profiles includes determining, for each eSIM 208 profile of the one or more eSIM 208 profiles, an activity usage status based on an activation status and a frequency of use. In some embodiments, the one or more ordered rankings of the one or more eSIM 208 profiles and/or applets includes a first ordered ranking of eSIM 208 profiles and a second ordered ranking of applets, where inactive eSIM 208 profiles and expired applets are prioritized for removal.

### Representative Exemplary Apparatus

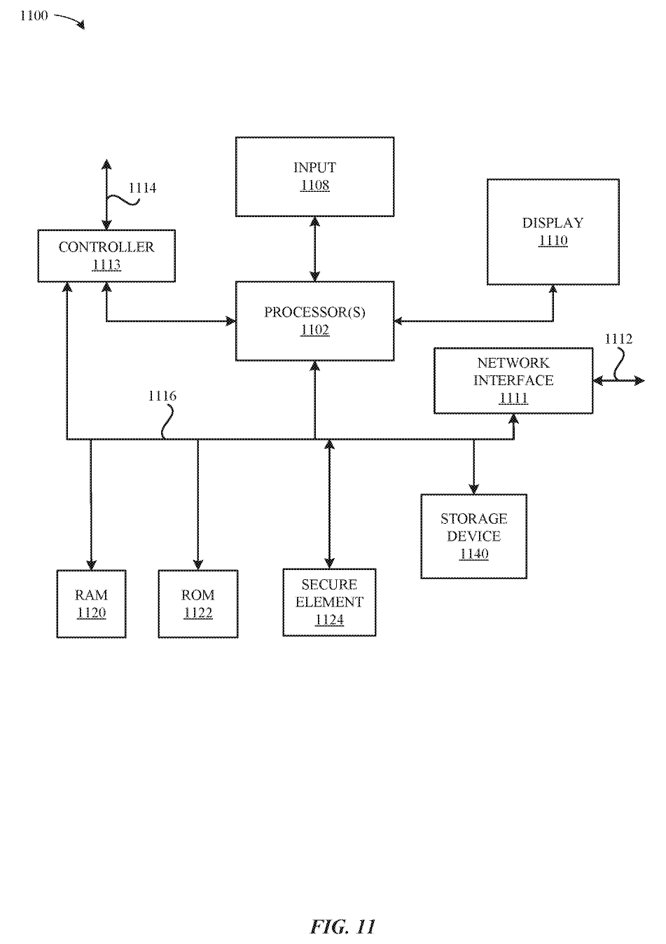

FIG. 11 illustrates in block diagram format an exemplary computing device 1100 that can be used to implement the various components and techniques described herein, according to some embodiments. In particular, the detailed view of the exemplary computing device 1100 illustrates various components that can be included in a UE 302 or a wireless device 102. As shown in FIG. 11, the computing device 1100 can include one or more processors 1102 that represent microprocessors or controllers for controlling the overall operation of computing device 1100. In some embodiments, the computing device 1100 can also include a user input device 1108 that allows a user of the computing device 1100 to interact with the computing device 1100. For example, in some embodiments, the user input device 1108 can take a variety of forms, such as a button, keypad, dial, touch screen, audio input interface, visual/image capture input interface, input in the form of sensor data, etc. In some embodiments, the computing device 1100 can include a display 1110 (screen display) that can be controlled by the processor(s) 1102 to display information to the user (for example, information relating to incoming, outgoing, or active communication sessions). A data bus 1116 can facilitate data transfer between at least a storage device 1140, the processor(s) 1102, and a controller 1113. The controller 1113 can be used to interface with and control different equipment through an equipment control bus 1114. The computing device 1100 can also include a network/bus interface 1111 that couples to a data link 1112. In the case of a wireless connection, the network/bus interface 1111 can include wireless circuitry, such as a wireless transceiver and/or baseband component. The computing device 1100 can also include a secure element 1124, which can be configured to store one or more SIM profiles and/or eSIM 208 profiles. The secure element 1124 can include an eUICC 108, an iUICC, one or more UICCs 118, and/or a component that includes a combination of an eUICC 108 and an embedded SE processor.

The computing device 1100 also includes a storage device 1140, which can include a single storage or a plurality of storages (e.g., hard drives and/or solid-state drives), and includes a storage management module that manages one or more partitions within the storage device 1140. In some embodiments, storage device 1140 can include flash memory, semiconductor (solid state) memory or the like. The computing device 1100 can also include a Random-Access Memory (RAM) 1120 and a Read-Only Memory (ROM) 1122. The ROM 1122 can store programs, utilities or processes to be executed in a non-volatile manner. The RAM 1120 can provide volatile data storage, and stores instructions related to the operation of the computing device 1100.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to manage memory storage of a secure element of a wireless device, the method comprising:
by one or more modules of the wireless device:
receiving, from a network provisioning server, first metadata for a first electronic subscriber identity module (eSIM) profile for access to a cellular wireless service, the first metadata comprising an estimated installed memory size for the first eSIM profile;
responsive to a determination that the estimated installed memory size for the first eSIM profile does not satisfy a memory requirement of a memory of the secure element, sending to the network provisioning server, a message that comprises an indication that a smaller size eSIM profile is required; and
responsive to receipt, from the network provisioning server, second metadata for a second eSIM profile for access to the cellular wireless service, the second metadata comprising a second estimated installed memory size for the second eSIM profile that satisfies the memory requirement, obtaining and installing the second eSIM profile on the memory of the secure element.

2. The method of claim 1, wherein the message comprises a second client authentication message sent after completion of a mutual authentication procedure between the network provisioning server and the secure element of the wireless device, where the mutual authentication procedure comprises a first client authentication message sent to the network provisioning server.

3. The method of claim 2, wherein the second client authentication message is sent to the network provisioning server without restarting a second mutual authentication procedure between the network provisioning server and the secure element of the wireless device.

4. The method of claim 2, wherein the second client authentication message is sent to the network provisioning server during a second mutual authentication procedure between the network provisioning server and the secure element of the wireless device.

5. The method of claim 1, wherein the message comprises a smaller profile flag to indicate a request for a smaller size eSIM profile.

6. The method of claim 1, wherein the message comprises an indication of a preferred memory size for a smaller size eSIM profile.

7. The method of claim 1, wherein the message is communicated via an ES9+ standardized interface during a mutual authentication procedure between a local profile assistant (LPA) of the wireless device and the network provisioning server.

8. The method of claim 1, wherein the secure element comprises an embedded universal integrated circuit card (eUICC).

9. The method of claim 1, wherein the memory is shared by an embedded universal integrated circuit card (eUICC) and an embedded secure element (eSE) processor of the wireless device.

10. A method to manage memory storage of a secure element of a wireless device, the method comprising:
by one or more modules of the wireless device:
receiving, from a network provisioning server, metadata for an electronic subscriber identity module (eSIM) profile for access to a cellular wireless service, the metadata comprising an estimated installed memory size for the eSIM profile;
responsive to a determination that the estimated installed memory size for the eSIM profile does not satisfy a memory requirement of the secure element of the wireless device, performing a memory management procedure to remove one or more eSIM profiles and/or one or more applets from a memory of the secure element; and
responsive to a determination that the estimated installed memory size for the eSIM profile satisfies the memory requirement of the secure element after performance of the memory management procedure, obtaining and installing the eSIM profile on the memory of the secure element.

11. The method of claim 10, wherein performing the memory management procedure comprises deleting an eSIM profile or an applet from the memory of the secure element.

12. The method of claim 11, wherein performing the memory management procedure further comprises:
presenting, via an output interface of the wireless device, an ordered ranking of one or more eSIM profiles and/or one or more applets installed on the memory of the secure element; and
obtaining, via an input interface of the wireless device, a selection of the eSIM profile or the applet to delete from the memory of the secure element.

13. The method of claim 11, wherein performing the memory management procedure further comprises:
sending, to the secure element, a pause session message to suspend a provisioning session for the eSIM profile between the secure element and the network provisioning server prior to deletion of the eSIM profile or the applet from the memory of the secure element; and
sending, to the secure element, a resume session message to resume the provisioning session for the eSIM profile after deletion of the eSIM profile or the applet from the memory of the secure element.

14. The method of claim 13, wherein the pause session message and the resume session message are communicated via an ES10b standardized interface between a local profile assistant (LPA) of the wireless device and the secure element.

15. The method of claim 10, wherein performing the memory management procedure further comprises:
offloading the eSIM profile or applet from the memory of the secure element to local storage of the wireless device or to remote storage external to the wireless device prior to deletion of the eSIM profile or applet.

16. The method of claim 10, wherein the metadata for the eSIM profile is included in a message received from the network provisioning server prior to receipt of a bound profile package (BPP) that comprises the eSIM profile.

17. The method of claim 10, wherein the metadata for the eSIM profile is included in a bound profile package (BPP) that comprises the eSIM profile received from the network provisioning server.

18. The method of claim 10, wherein the secure element comprises an embedded universal integrated circuit card (eUICC).

19. The method of claim 10, wherein the memory is shared by an embedded universal integrated circuit card (eUICC) and an embedded secure element (eSE) processor of the wireless device.

20. A method to manage memory storage of a secure element of a wireless device, the method comprising:
by one or more modules of the wireless device:
receiving, from the secure element of the wireless device during an electronic subscriber identity module (eSIM) profile provisioning procedure, an error message indicating insufficient memory to store an eSIM profile on a memory of the secure element;
pausing the eSIM profile provisioning procedure to download and install the eSIM profile to the memory of the secure element;
performing a memory management procedure to remove an eSIM profile or an applet from the memory of the secure element; and
resuming the eSIM profile provisioning procedure to download and install the eSIM profile to the memory of the secure element.
